(19) United States
(12) Patent Application Publication
(10) Pub. No.: US 2016/0238433 A1
(43) Pub. Date: Aug. 18, 2016

(54) ELECTRONIC DEVICE

(71) Applicants: Qisda (Suzhou) Co., Ltd., Suzhou (CN); Qisda Corporation, Taoyuan (TW)

(72) Inventors: Chia-Jung Kuo, Hsinchu (TW); Ming-Feng Liu, Hsinchu (TW); Kai-Ti Chang, Hsinchu (TW); Hsiu-Ching Cho, New Taipei (TW)

(21) Appl. No.: 15/014,032

(22) Filed: Feb. 3, 2016

(30) Foreign Application Priority Data
Feb. 17, 2015 (TW) 104105680

(51) Int. Cl. G01G 19/52; G06F 3/041; G06F 1/16; G06F 3/044

(52) U.S. Cl. CPC G01G 19/52; G06F 3/044; G06F 3/0416; G06F 1/1626; G06F 2203/04105

(57) ABSTRACT

An electronic device includes a housing, a touch panel, a processor and one or more conductive rubbers. The touch panel has a contact surface. The processor is disposed inside the housing and coupled to the touch panel. When the one or more conductive rubbers contact the contact surface of the touch panel and the one or more conductive rubbers are compressed by a gravity provided by an object, the processor detects a first value on touch panel and obtains a weight of the object according to the first value.

### FIELD OF THE INVENTION

The present invention relates to an electronic device, and more particularly to an electronic device with weight measuring function.

### BACKGROUND OF THE INVENTION

With the advancement of technology, various electronic devices are widely used in people's daily lives. Today, more and more electronic devices are equipped with touchpad or touch panel for enhanced user experiences. In general, touchpad or touch panel utilizes capacitive sensing or resistive sensing for touch sensing. Specifically, capacitive touch panels determine the coordinate of points of touch by detecting the induced current generated by capacitance change resulted from electrostatic combination between a plurality of transparent electrodes and the human body. In contract, resistive touch panels have an upper ITO conductive layer and a lower ITO conductive layer having electrodes conductive to each other upon pressure, and determine the coordinate of touch points by calculating voltage change on the panel. As compared with resistive touch panels, capacitive touch panels have better touch performance and shorter response time; therefore, capacitive touch panels have been widely used in consumer electronic products due to their high sensitivity and responsiveness. Further, capacitive touch panels tend to have longer device lifetime.

In addition to capacitive touch panels, more expandable functions in existing electronic devices are expected. For example, a traveler may need to measure the weight of his or her luggage at the airport before checking in. However, most travelers typically would not bring a weighing device along to the airport, and therefore some may have to spend extra time on the boarding procedure for overweight luggage. In addition, a shopper may need to measure the weight of purchased items while shopping. However, some shoppers may be taken advantage of if they do not have a weighing device on hand and cannot examine the weight of the merchandise before purchasing. To date, no existing electronic device can provide simple and accurate weight measuring function. Additionally, extra weighing circuits would be required if having to combine an electronic device with a weight measuring system, which would impact not only the power consumption but also the volume of the circuit layout.

Therefore, there is a need to develop an electronic device capable of providing a weight measuring function without having to alter the original internal circuit configuration of the electronic device.

### SUMMARY OF THE INVENTION

Therefore, the present invention provides an electronic device, which includes a housing, a touch panel, a processor and one or more conductive rubbers. The touch panel has a contact surface. The processor is disposed inside the housing and coupled to the touch panel. When the one or more conductive rubbers contact the contact surface of the touch panel and the one or more conductive rubbers are compressed by a gravity provided by an object, the processor detects a first value on the touch panel and obtains a weight of the object according to the first value.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of the structure of an electronic device in accordance with the first embodiment of the present invention;

FIG. 2 is a schematic view of weight information displayed by a touch panel display while the electronic device of FIG. 1 is initializing;

FIG. 3 is a schematic view of weight information displayed by a touch panel display while the electronic device of FIG. 1 is weighing;

FIG. 4 is a schematic diagram of the structure of an electronic device in accordance with the second embodiment of the present invention;

FIG. 5 is a schematic diagram of the structure of an electronic device in accordance with the third embodiment of the present invention;

FIG. 6 is a schematic diagram of the structure of an electronic device in accordance with the fourth embodiment of the present invention;

FIG. 7A is a schematic diagram of the structure of an electronic device in accordance with the fifth embodiment of the present invention;

FIG. 7B is a schematic cross-sectional view of the electronic device, taken along line P-P′ in FIG. 7A; and

FIG. 8 is a schematic diagram of the structure of an electronic device in accordance with the sixth embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

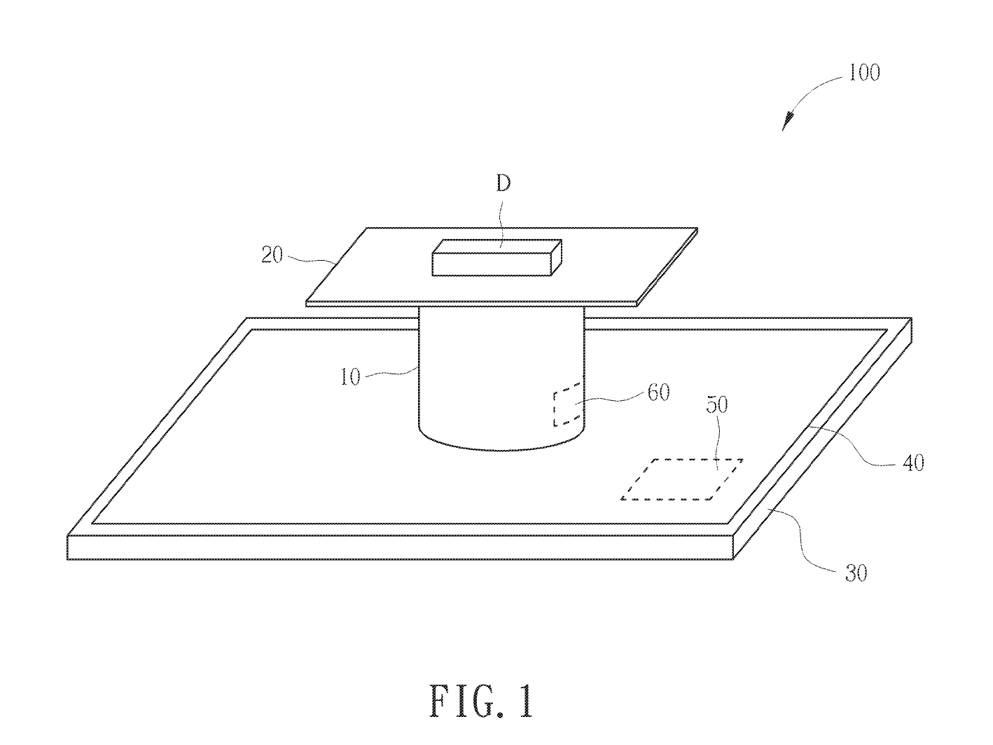

FIG. 1 is a schematic illustration of the structure of an electronic device in accordance with the first embodiment of the present invention. As shown in FIG. 1, the electronic device 100 of the present embodiment includes a conductive rubber 10, a carrier 20, a housing 30, a touch panel 40 and a processor 50. The electronic device 100 is configured to measure the weight of an object D. The touch panel 40 is disposed on one surface of the housing 30 and has a contact surface for sensing the contact area between the object D and the contact surface. The processor 50 is disposed inside the housing 30 and coupled to the touch panel 40. The carrier 20 is used to bear the object D. The conductive rubber 10 is disposed between the contact surface of the touch panel 40 and the carrier 20. The conductive rubber 10 has a ground port 60 for grounding the conductive rubber 10 so to improve the weighing efficiency of the electronic device 100. The carrier 20 is disposed between the object D and the conductive rubber 10. In the present embodiment, the carrier 20 may be any object capable of bearing the object D and may be made of metal or non-metal materials. The conductive rubber 10 utilizes high-performance silicone rubber as the base material, combining with special fillers (such as copper coated silver, aluminum coated silver, glass coated silver and graphite coated nickel particles, etc.) and additives. The conductive rubber 10 in the present embodiment may be any conductive object with certain elastic coefficient; wherein the elastic coefficient is not limited in the present invention. However, taking factors such as cost, loss and deformation capacity into consideration, nickel-copper, silver-glass and silver coated copper are preferably selected as the conductive fillers in the present embodiment, so that the electronic device of the present invention is more effective. In the present embodiment, the touch panel 40 is a capacitive touch panel. When being touched, the touch panel 40 is configured to generate capacitance via self-capacitance sensing or mutual-capacitance sensing. When the conductive rubber 10 is grounded via the ground port 60, the electronic device 100 has higher weighing efficiency due to the area of contact between the conductive rubber 10 and the contact surface of the touch panel 40 having a wide dynamic range of capacitance. In the present embodiment, based on the positive downward force (or gravity) provided by the object D, the processor 50 is configured to calculate the weight of the object D according to the capacitance generated between the touch panel 40 and the conductive rubber 10 via a look-up table or a transfer function. In the present embodiment, the electronic device 100 uses the carrier 20 to bear the object D; however, the present invention is not limited thereto. In another embodiment, the electronic device 100 may use the conductive rubber 10 to directly bear the object D. The weighing process and weighing principle of the electronic device 100 of the present embodiment will be described in detail as follows.

Following provides an example for demonstrating the weighing process and weighing principle of the electronic device 100. When using the electronic device 100 to measure the weight of the object D having an actual weight W_{D}, firstly a user would have to place the object D onto the carrier 20 of the electronic device 100. The gravity of the object D is transmitted to the conductive rubber 10 through the carrier 20 and causes deformation (i.e., compression) of the conductive rubber 10. At this moment, the total weight received at the bottom of the conductive rubber 10 is the sum of the weight W_{D} of the object D, weight W₂₀ of the carrier 20 and weight W₁₀ of the conductive rubber 10. It is to be understood that compressional deformation of the conductive rubber 10 would increase the bottom area of the conductive rubber 10, therefore increasing the contact area between the conductive rubber 10 and the contact surface of the touch panel 40. As described above, the touch panel 40 is a capacitive touch panel in the present embodiment, thus satisfying the formula for contact capacitance: C=∈A/d; wherein C is the equivalent contact capacitance value, ∈ is the dielectric constant, A is the contact area, and d is the equivalent distance between two capacitor plates. According to the formula, the contact capacitance value C is positively proportional to the contact area A under fixed ∈ and d; that is, the contact capacitance value C increases with the increase of the contact area A between the conductive rubber 10 and the contact surface of the touch panel 40. After detecting the contact area A of the touch panel 40 resulted from the aforementioned gravity and obtaining the corresponding contact capacitance value C, the processor 50 would calculate the estimated weight W_{Est} of the object D via the look-up table or transfer function. If the estimated weight W_{Est} calculated by the processor 50 is highly accurate, the estimated weight W_{Est} of the object D would satisfy the equation W_{Est}=W_{D}+W₁₀+W₂₀. In order to obtain the actual weight W_{D} of the object D, the initial weight of the electronic device 100 (that is, the sum of the weight W₂₀ of the carrier 20 and the weight W₁₀ of the conductive rubber 10) must be obtained first. Therefore, the user would have to remove the object D from the carrier 20 of the electronic device 100. At this moment, the total weight received at the bottom of the conductive rubber 10 is the sum of the weight W₂₀ of the carrier 20 and the weight W₁₀ of the conductive rubber 10. As the weight received by the conductive rubber 10 has reduced, the conductive rubber 10 has decreased bottom area due to milder compressional deformation. Therefore, the contact area A between the conductive rubber 10 and the contact surface of the touch panel 40 would decrease, resulting in reduced contact capacitance value C. After detecting the contact area A of the touch panel 40 without the gravity of the object D and obtaining the corresponding contact capacitance value C, the processor 50 would calculate the initial weight Wᵢₙᵢ of the electronic device 100 via the look-up table or transfer function. The initial weight Wᵢₙᵢ of the electronic device 100 would satisfy the equation W_{Ini}=W₁₀+W₂₀ if the initial weight Wᵢₙᵢ calculated by the processor 50 is highly accurate. Thereafter, the processor 50 may obtain a calculated weight W_{D}_{_}_{Est} of the object D by subtracting the initial weight Wᵢₙᵢ from the estimated weight W_{Est}, that is W_{D}_{_}_{Est}→W_{Ini}.

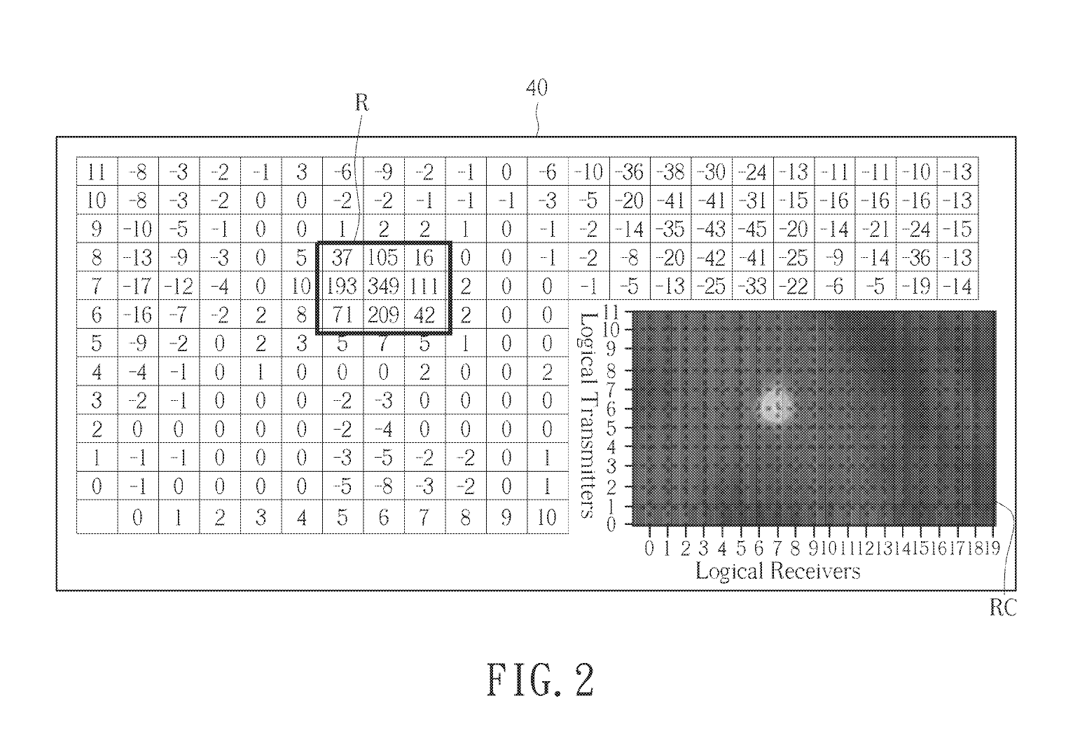

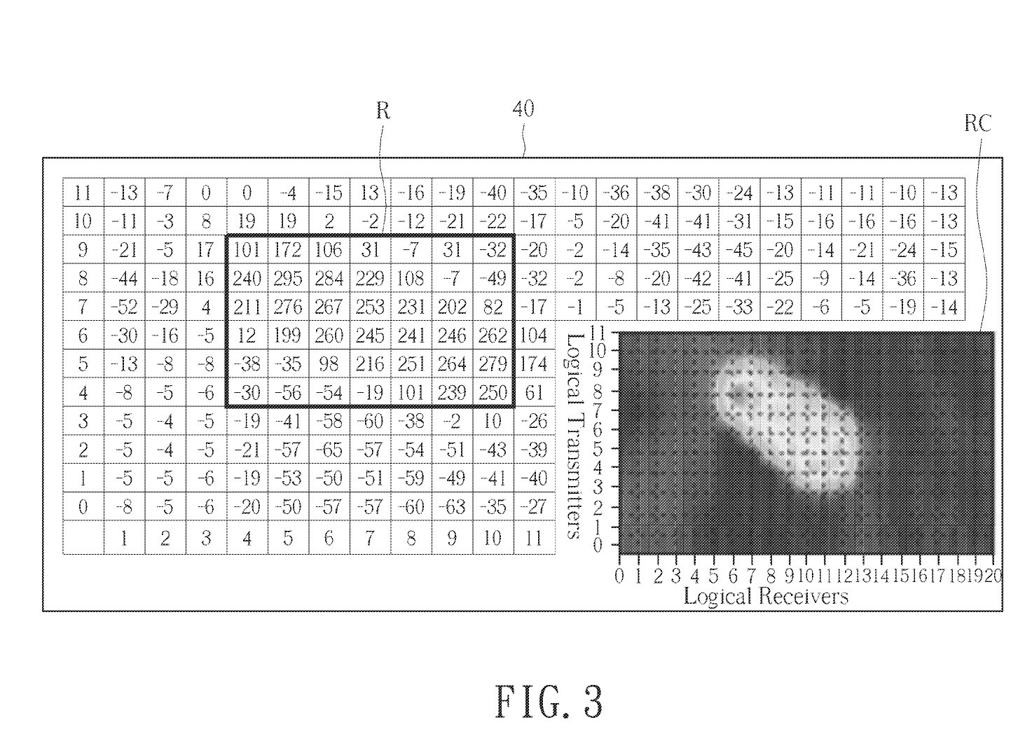

FIG. 2 is a schematic illustration of weight information displayed by a touch panel display of the electronic device 100 when initializing. FIG. 3 is a schematic illustration of weight information displayed by the touch panel display while the electronic device 100 is weighing. In the present embodiment, the touch panel 40 is a touch panel display. In FIG. 2, the information displayed by the touch panel 40 is the analog to digital converter (ADC) values corresponding to contact area R between the conductive rubber 10 and the contact surface of the touch panel 40, and the ADC values corresponding to the area outside the contact area R. As shown in FIG. 2, the ADC values in the contact area R are much higher than the ADC values outside the contact area R. In the present embodiment, the ADC values in the contact area R are positively proportional to the contact capacitance value C between the conductive rubber 10 and the touch panel 40; therefore, a higher ADC value represents a larger gravity received by the touch panel 40. In the present embodiment, as the touch panel 40 is a capacitive touch panel, the touch panel 40 includes a touch signal transmitting layer and a touch signal receiving layer, and each of the layers includes a plurality of touch signal transmitting lines and touch signal receiving lines. As shown in FIG. 2, the touch panel 40 may also display a display area RC, showing the coordinate of the area of contact between the conductive rubber 10 and the contact surface of the touch panel 40. Specifically, the horizontal axis of the coordinate represents the index of the touch signal receiving lines (or logical receivers), and the vertical axis represents the index of the touch signal transmitting lines (or logical transmitters). In addition, the highlighted area in the display area RC represents the contact area between the conductive rubber 10 and the contact surface of the touch panel 40. In FIG. 3, similarly, the touch panel 40 also displays the ADC values corresponding to the contact area R between the conductive rubber 10 and the contact surface of the touch panel 40 and the ADC values corresponding to the area outside the contact area R. In addition, the touch panel 40 in FIG. 3 also displays in the display area RC the area and coordinate of contact between the conductive rubber 10 and the contact surface of the touch panel 40. In contrast to the initialization state of the electronic device 100 in which the object D is not loaded as in FIG. 2, the electronic device 100 loaded with the object D as in FIG. 3 has a larger contact area R as the conductive rubber 10 is further compressed by the gravity provided by the loaded object D. Additionally, the highlighted area in the display area RC in FIG. 3 is also larger than that in FIG. 2, representing that the compression of the conductive rubber 10 by the gravity of the object D has caused the contact area between the conductive rubber 10 and the contact surface of the touch panel 40 to cover more touch signal transmitting lines and touch signal receiving lines. In the present embodiment, the touch panel 40 is able to display real-time information such as the coordinate, area, value (e.g., ADC value) of the contact area between the conductive rubber 10 and the contact area of the touch panel 40, therefore allowing a user to observe and assess in real-time the gravity change while the electronic device 100 is weighing the object D.

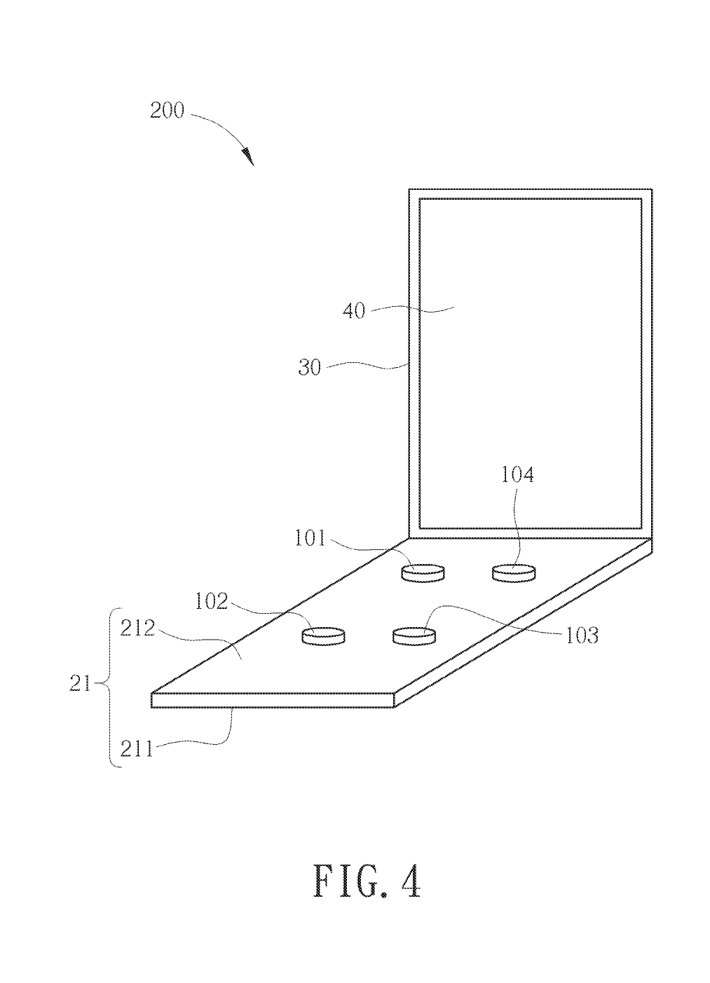

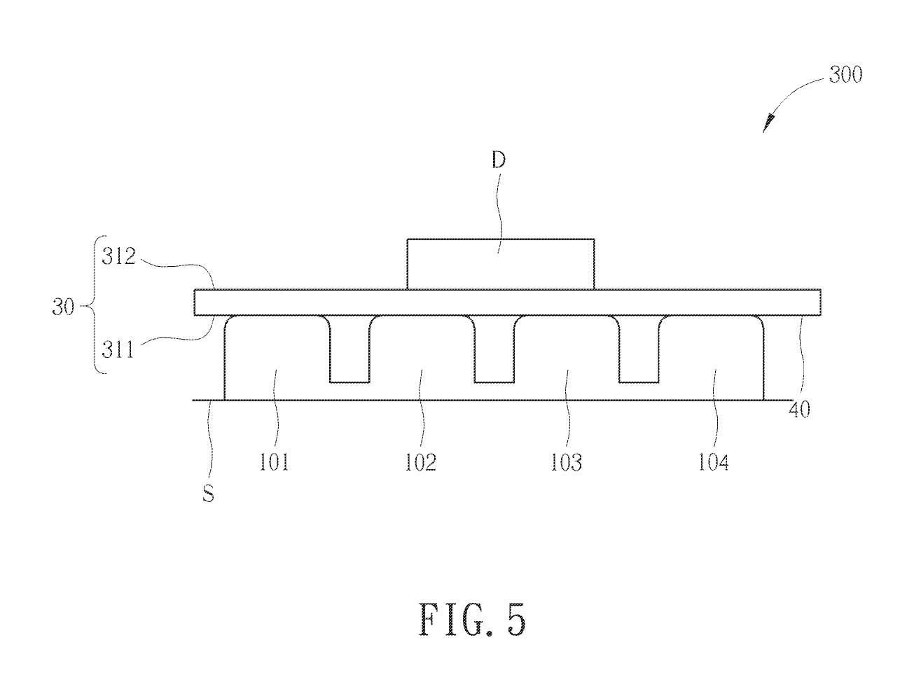

FIGS. 4 and 5 are schematic diagrams showing the structure of electronic devices in accordance with other embodiments of the present invention. In the embodiments of FIGS. 4 and 5, the conductive rubber 10 is a combination of a plurality of conductive rubbers 101, 102, 103 and 104 with an identical elastic coefficient. In the embodiments of FIGS. 4 and 5, the conductive rubbers 101, 102, 103 and 104 are compressionally deformed by being compressed by the gravity of the object D. After detecting the contact area A1, which is the sum of the contact areas between each of the conductive rubbers 101, 102, 103 and 104 and the touch panel 40, and obtaining the corresponding contact capacitance value C, the processor 50 can calculate the weight W_{D} of the object D via the look-up table or transfer function. As the process of weighing the object D in the embodiments illustrated in FIGS. 4 and 5 is identical to that in the first embodiment, no redundant detail is to be given herein. It is to be noted that if the conductive rubbers 101, 102, 103 and 104 have different elastic coefficients or other characteristics, respective look-up tables or transfer functions for each of the conductive rubbers 101, 102, 103 and 104 are required for weighing of the object D, instead of simply performing the aforementioned summing operation. The structures and weighing process of the electronic devices of the embodiments shown in FIGS. 4 and 5 will be described in detail as follows.

FIG. 4 is a schematic illustration of the structure of an electronic device in accordance with the second embodiment of the present invention. As shown in FIG. 4, the electronic device 200 of the present embodiment includes a back cover 21. One side (e.g., the upper side in the present embodiment) of the back cover 21 is pivotally connected to one side (e.g., the lower side) of the housing 30. In one embodiment, the back cover 21 is also used as a shell casing of the electronic device 200 for protecting the housing 30 and is pivotally secured onto the housing 30; that is, when folded with respect to the touch panel 40, the back cover 21 may also provide protection for the touch panel 40 or battery (not shown). The back cover 21 has a first surface 211 and a second surface 212. The conductive rubbers 101, 102, 103 and 104 are disposed on the second surface 212. When using the electronic device 200 to measure the weight W_{D} of the object D, firstly a user would have to let the conductive rubbers 101, 102, 103 and 104 on the second surface 212 of the back cover 21 contact the contact surface of the touch panel 40, and place the object D on the first surface 211 of the back cover 211, thereby making the first surface 211 of the back cover 211 to bear the object D. The gravity of the object D is transmitted to the conductive rubbers 101, 102, 103 and 104 via the back cover 211, and therefore causing deformation of the conductive rubbers 101, 102, 103 and 104. Thereafter, the processor 50 may calculate the weight W_{D} of the object D in accordance with the deformation of the conductive rubbers 101, 102, 103 and 104. Similarly, in the present embodiment shown in FIG. 4, the processor 50 may obtain the weight W_{D} of the object D by subtracting the initial weight Wᵢₙᵢ from the estimated weight W_{Est}. In the present embodiment, it is to be understood that the estimated weight W_{Est} is the sum of the weight W_{D} of the object D, the total weight W₁₀ of the conductive rubbers 101, 102, 103 and 104, and the weight of the back cover 21; and the initial weight Wᵢₙᵢ is the sum of the total weight W₁₀ of the conductive rubbers 101, 102, 103 and 104 and the weight of the back cover 21. In the present embodiment, the electronic device 200 uses the back cover 21 to bear the object D; however, the present invention is not limited thereto. In another embodiment, the electronic device 200 may use any flat object (e.g., a side cover) that can pivotally connect to the housing 30 to bear the object D.

FIG. 5 is a schematic illustration of the structure of an electronic device in accordance with the third embodiment of the present invention. As shown in FIG. 5, the housing 30 of the electronic device 300 of the present embodiment has a first surface 311 and a second surface 312. The touch panel 40 is disposed on the first surface 311 and has a contact surface. The second surface 312 is used to bear the object D. In the electronic device 300, the conductive rubbers 101, 102, 103 and 104 are disposed on a plane S. The conductive rubbers 101, 102, 103 and 104 are used to bear the housing 30 and contact the contact surface of the touch panel 40. In the present embodiment, the housing 30 is functioned as a bearing plate for bearing the object D. When using the electronic device 300 to measure the weight W_{D} of the object D, firstly a user would have to place the object D on the second surface 312 of the housing 30. The gravity of the object D is transmitted to the conductive rubbers 101, 102, 103 and 104 via the housing 30, and therefore deforms the conductive rubbers 101, 102, 103 and 104. Thereafter, the processor 50 may calculate the weight W_{D} of the object D in accordance with the deformation of the conductive rubbers 101, 102, 103 and 104. Similarly, in the present embodiment of FIG. 5, the processor 50 may obtain the weight W_{D} of the object D by subtracting the initial weight Wᵢₙᵢ from the estimated weight W_{Est}. In the present embodiment, it is to be understood that the estimated weight W_{Est} is the sum of the weight W_{D} of the object D and the total weight of the housing 30 and the internal components therein; and the initial weight Wᵢₙᵢ is the total weight of the housing 30 and the internal components therein. In the present embodiment, as having to bear the electronic device 300 (specifically, the housing 30), the conductive rubbers 101, 102, 103 and 104 may be designed in one-piece. For example, as shown in FIG. 5, the lower parts of the conductive rubbers 101, 102, 103 and 104 are connected and integrated into one piece; thus, the conductive rubbers 101, 102, 103 and 104 can support the electronic device 300 more stably. In one embodiment, the conductive rubbers 101, 102, 103 and 104 may be arranged in a three-point or linear structure in accordance with the demands of the user.

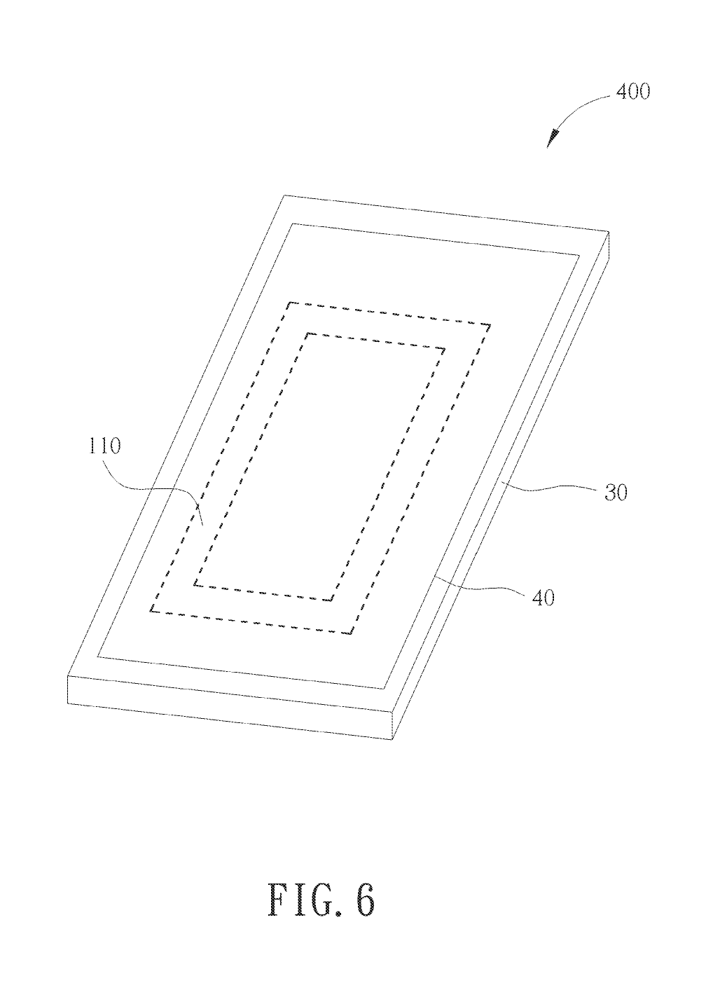

FIG. 6 is a schematic illustration of the structure of an electronic device in accordance with the fourth embodiment of the present invention. As shown in FIG. 6, the conductive rubber 110 of the electronic device 400 of the present embodiment is disposed inside the housing 30 and the touch panel 40 can move upwards and downwards with respect to the housing 30. Specifically, the conductive rubber 110 is disposed between the back surface of the touch panel 40 and the bottom surface of the housing 30; wherein touch function of the touch panel 40 is implemented on the back surface thereof. When using the electronic device 400 to measure the weight W_{D} of the object D, firstly a user would have to place the object D on the touch panel 40. The gravity of the object D is transmitted to the conductive rubber 110 disposed inside the housing 30 via the touch panel 40, and therefore the conductive rubber 110 deforms and contacts the back surface of the touch panel 40. Thereafter, the processor 50 may calculate the weight W_{D} of the object D in accordance with the deformation of the conductive rubber 110 (specifically, the contact area between the conductive rubber 110 and the back surface of the touch panel 40). As shown in FIG. 6, the conductive rubber 110 is disposed along the four sides of the housing to support the touch panel 40; however, the present invention is not limited thereto.

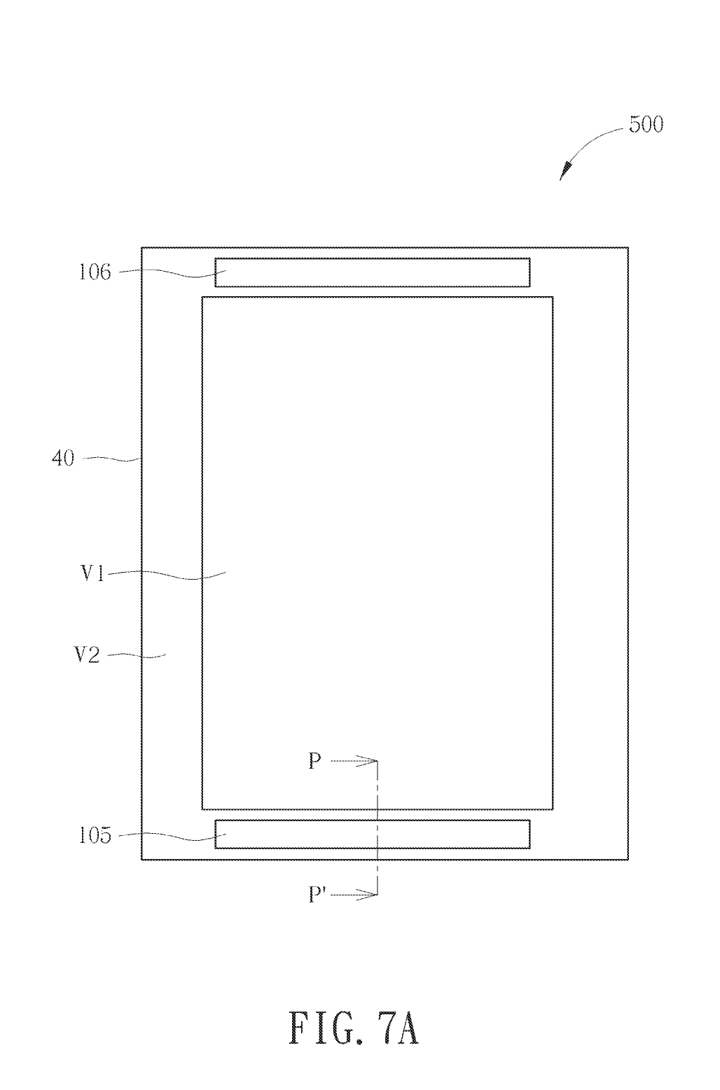

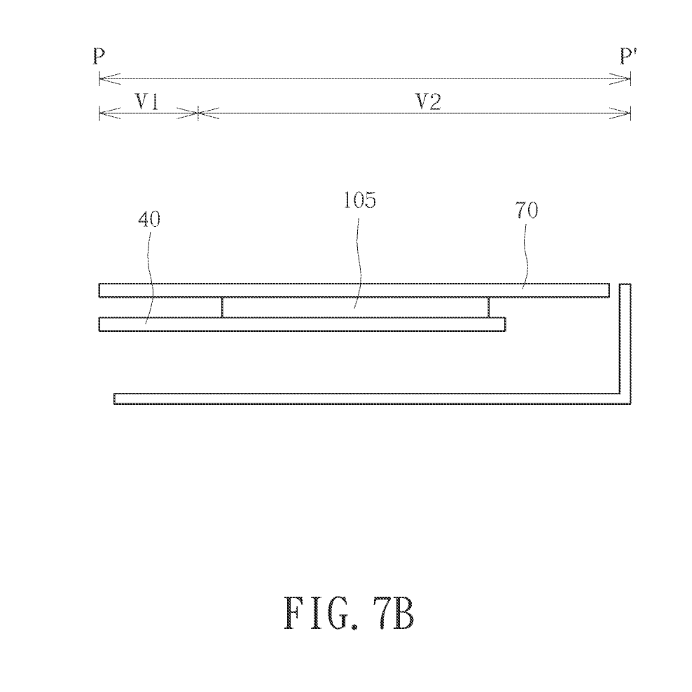

FIG. 7A is a schematic illustration of the structure of an electronic device in accordance with the fifth embodiment of the present invention. As shown in FIG. 7A, a surface of the electronic device 500 of the present embodiment adjacent to the touch panel 40 includes a display area V1 and a non-display area V2. The display area V1 is used to display images and the non-display area V2 is an area without display function for disposing receiving buttons or touch symbols. The conductive rubbers 105 and 106 may be enclosed within the housing 30. FIG. 7B is a schematic cross-sectional view of the electronic device, taken along line P-P′ in FIG. 7A. As shown in FIG. 7B, surface of the electronic device 500 is disposed with a transparent protective plate 70, having an area approximately equaling the area of the surface (e.g., the upper surface) of the electronic device 500. The conductive rubber 105 and the touch panel 40 are disposed under the transparent protective plate 70. The touch panel 40 is secured by the internal structure of the housing 30. In the embodiment shown in FIG. 7A, the conductive rubbers 105 and 106 are disposed on two sides of the electronic device 500 to support the transparent protective plate 70. When the object D is placed on the transparent protective plate 70, the transparent protective plate 70 may move with respect to the housing 30 in response to the gravity of the object D; and consequently, the conductive rubbers 105 and 106 may deform, accompanied by change in the areas of contact between the conductive rubbers 105, 106 and the touch panel 40. Compared with the previously described embodiments, the difference lies in that the touch panel 40 in the present embodiment is disposed corresponding not only to the display area V1 but also to the non-display area V2, so as to achieve the weighing function of the present invention. When using the electronic device 500 to measure the weight W_{D} of the object D, firstly a user would have to place the object D on the transparent protective plate 70. The gravity of the object D is transmitted to the conductive rubbers 105 and 106 via the transparent protective plate 70, and therefore deforms the conductive rubbers 105 and 106. Thereafter, the processor 50 may calculate the weight W_{D} of the object D in accordance with the deformation of the conductive rubbers 105 and 106.

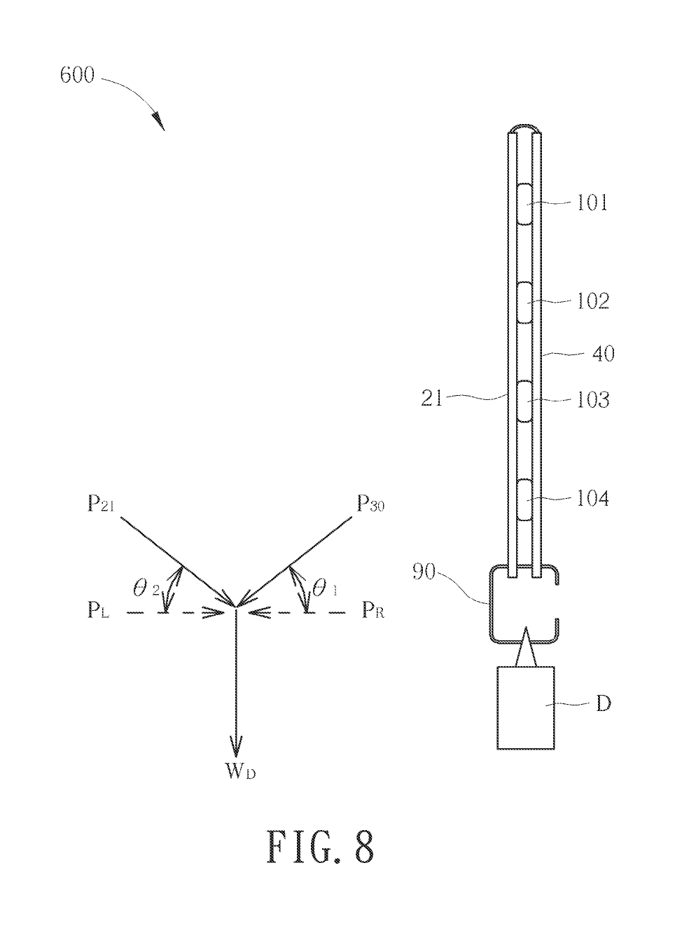

FIG. 8 is a schematic illustration of the structure of an electronic device in accordance with the sixth embodiment of the present invention. As shown in FIG. 8, the electronic device 600 of the present embodiment is similar to the electronic device 200 in FIG. 4. The difference lies in that the electronic device 600 of the present embodiment includes a hook 90. The hook 90 is connected to a side (e.g., the lower side) of the back cover 21 and a side (e.g., the lower side) of the housing 30. The hook 90 is used to hang the object D thereon. When using the electronic device 600 to measure the weight W_{D} of the object D, firstly a user would have to hang the object D onto the hook 90. As the hook 90 is connected to the lower sides of the back cover 21 and the housing 30, a positive downward force (that is, the weight W_{D}) provided by the object D is equal to the resultant force of the pressure P₂₁ received by the back cover 21 and the pressure P₃₀ received by the housing 30. In this case, the conductive rubbers 101, 102, 103 and 104 are compressed by the horizontal component P_{L} of the pressure P₂₁ and the horizontal component P_{R} of the pressure P₃₀. More precisely, the pressures P_{R}, P_{L}, P₂₁ and P₃₀ satisfy the following equations: P_{R}=P₃₀ cos(θ₁) and P_{L}=P₂₁ cos(θ₂); wherein θ₁ is the angle between the pressures P_{R} and P₃₀, θ₂ is the angle between the pressures P_{L} and P₂₁. As the conductive rubbers 101, 102, 103 and 104 are deformed upon compression by the pressures P_{R} and P_{L}, the contact areas A1 between the conductive rubbers 101, 102, 103 and 104 and the touch panel 40 would change and the processor 50 may calculate the weight W_{D} of the object D accordingly.

In the aforementioned embodiments as described above, the conductive rubbers 101, 102, 103 and 104 are used for exemplary purpose only; that is, the number of the conductive rubber is not limited in the aforementioned embodiments. Further, the cylindrical conductive rubbers in the aforementioned embodiments are only exemplary; the shape of the conductive rubbers of the present invention is not limited thereto. However, it is to be understood that conductive rubbers with cylinder structure can respond to the impact of the gravity on the contact area more sensitively due to an even distribution of force around the cylinder structure; therefore electronic devices having cylinder-structured conductive rubbers can weigh more accurately.

In summary, the present invention provides an electronic device with weight measuring function without having to alter the original internal circuit configuration of the electronic device. Specifically, the weight measuring function of the electronic device of the present invention is realized by employing at least one conductive rubber, which deforms upon compression by a gravity provided by an object. The deformation of the conductive rubber causes a change in the area of contact between the conductive rubber and the contact surface of the touch panel of the electronic device. Therefore, the processor of the electronic device may calculate the weight of the object according to the change in contact area. In the present invention, the conductive rubber and the housing of the electronic device may be integrated into one-piece, therefore enabling the user to carry a small weighing device simultaneously with the electronic device. Consequently, the electronic device of the present invention is highly convenient especially for occasions in which self measurement of weight is required.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic device, comprising:
a housing;
a touch panel, having a contact surface;
a processor, disposed inside the housing and coupled to the touch panel; and
one or more conductive rubbers,
wherein when the one or more conductive rubbers contact the contact surface of the touch panel and the one or more conductive rubbers are compressed by a gravity provided by an object, the processor detects a first value on the touch panel and obtains a weight of the object according to the first value.

2. The electronic device according to claim 1, wherein when the gravity is removed, the processor detects a second value on the touch panel and calculates the weight of the object according to the first value, the second value and a transfer function.

3. The electronic device according to claim 2, wherein the first value and the second value are an area of contact between the one or more conductive rubbers and the contact surface of the touch panel.

4. The electronic device according to claim 1, further comprising a carrier, disposed between the one or more conductive rubbers and the object.

5. The electronic device according to claim 4, wherein the carrier is a side cover of the electronic device, the side cover is pivotally connected to a side of the housing, the side cover has a first surface and a second surface, the one or more conductive rubbers are disposed on the second surface, and the first surface is adopted to bear the object when the one or more conductive rubbers contact the contact surface of the touch panel.

6. The electronic device according to claim 4, wherein the carrier is a back cover of the electronic device, the back cover is secured onto the housing, the back cover has a first cover surface and a second cover surface, the one or more conductive rubbers are disposed on the second cover surface, and the first cover surface is adopted to bear the object when the one or more conductive rubbers contact the contact surface of the touch panel.

7. The electronic device according to claim 1, wherein the one or more conductive rubbers are at least two conductive rubbers, the first value is associated with a sum of areas of contact between the at least two conductive rubbers and the contact surface of the touch panel.

8. The electronic device according to claim 1, wherein the one or more conductive rubbers are disposed between the touch panel and the housing.

9. The electronic device according to claim 8, wherein the touch panel comprises a display area and a non-display area, and the one or more conductive rubbers are disposed between the display area of the touch panel and the housing.

10. The electronic device according to claim 8, wherein the touch panel comprises a display area and a non-display area, and the one or more conductive rubbers are disposed between the non-display area of the touch panel and the housing.

11. The electronic device according to claim 10, wherein the non-display area comprises a touch signal transmitting layer and a touch signal receiving layer, and the one or more conductive rubbers are disposed on a side of the touch signal transmitting layer and the touch signal receiving layer.

12. The electronic device according to claim 1, wherein the object and the one or more conductive rubbers are disposed on two opposite sides of the electronic device.

13. The electronic device according to claim 1, further comprising:
a back cover, wherein a first side of the back cover is connected to a first side of the housing; and
a hook, connected to a second side of the back cover and a second side of the housing, for hanging the object thereon,
wherein the one or more conductive rubbers are disposed between the touch panel and the back cover.

14. The electronic device according to claim 1, wherein the touch panel is a capacitive touch panel and the first value is a capacitance value.

15. The electronic device according to claim 14, wherein the capacitive touch panel generates the capacitance value via self-capacitance sensing.

16. The electronic device according to claim 14, wherein the capacitive touch panel generates the capacitance value via mutual-capacitance sensing.

17. The electronic device according to claim 1, wherein a ground port is coupled to the one or more conductive rubbers, for grounding the one or more conductive rubbers.

18. The electronic device according to claim 1, wherein the processor obtains the weight of the object by adopting a look-up table and the first value.

19. The electronic device according to claim 1, wherein the housing has a first surface and a second surface, the first surface comprises the contact surface, the housing is disposed between the one or more conductive rubbers and the object, and the second surface is adopted to bear the object.

20. The electronic device according to claim 1, wherein the touch panel is a touch panel display configured to display coordinate information, area information and weight information of an area of contact between the one or more conductive rubbers and the contact surface of the touch panel display.
